(19) United States
(12) Patent Application Publication
(10) Pub. No.: US 2008/0214169 A1
(43) Pub. Date: Sep. 4, 2008

(54) Method and Arrangement in a Telecommunication System

(75) Inventors: Johan Axnas, Solna (SE); Benny Lennartson, Hagersten (SE)

Correspondence Address: ERICSSON INC., 6300 LEGACY DRIVE, M/S EVR 1-C-11, PLANO, TX, 75024, US

(73) Assignee: Telefonaktiebolaget LM Ericsson (publ), Stockholm (SE)

(21) Appl. No.: 11/914,642

(22) PCT Filed: May 26, 2005
(86) PCT No.: PCT/SE05/00798

§ 371 Date: Nov. 16, 2007

(51) Int. Cl. H04B 17/00

(52) U.S. Cl. 455/418

(57) ABSTRACT

A method for comparing configurations in a telecommunication system comprises switching S1, S3 between two or more configurations, and for each configuration measuring S2, S4 some predetermined parameter. The switching and measuring steps are repeated at least one time during a predetermined time period. For each of the configurations the collected measurements are statistically evaluated S5. Subsequently, the evaluated parameters and consequently the configurations can be compared S6.

### TECHNICAL FIELD

The present invention relates to telecommunication systems in general, specifically to methods and arrangements for evaluating new features in such systems.

### BACKGROUND

For telecommunication operators it is often necessary to evaluate the impact of new features in the system. Such features may involve different combination techniques or interference suppression techniques.

In prior art this has generally been achieved by implementing the feature and measuring some quality parameter or set of quality parameters during a relatively long period e.g. a week. The long period is necessary in order to achieve reliable statistics. Subsequently, the feature is deactivated and the same parameters are measured during the next week. Finally, the results from the two weeks are evaluated and compared.

Unfortunately, the traffic load in the system can be substantially lower for one of the weeks e.g. holidays. This may prevent useful comparisons from being made. It is therefore difficult to identify the influence of the implemented feature from the fluctuations in the traffic load. It is also not possible to isolate the influence of the feature for an individual session e.g. phone call.

Consequently, there is a need for an improved manner in which to perform measurements for different sets of features and to perform meaningful comparisons between them.

### SUMMARY

An object of the present invention is to enable improved evaluation of the effect of an implemented feature in a telecommunication system.

A specific object is to enable a method of reliably comparing different configurations in a telecommunication system.

Another specific object enables comparing different configurations in general.

Yet another specific object is to enable reliable statistical evaluations of different configurations.

These and other objects are achieved in accordance with the attached claims.

Basically, the invention comprises switching between different configurations, for each switching cycle a predetermined parameter is measured. The switching and measuring steps are repeated during a predetermined time interval, and the respective configurations are separately statistically evaluated. Finally, the statistical evaluations for the configurations are compared.

The invention, according to a specific embodiment, comprises repeated activation/deactivation of the feature in question for very short intervals, e.g. every second burst. Some quality parameter is measured and collected for each interval. Subsequently, the collected measurements are evaluated separately for the intervals e.g. by averaging. Consequently, it is possible to achieve reliable statistics for respective interval that is marginally affected by the traffic distribution during the measuring period.

Generally, the invention can be described as repeated switching between two configurations, and evaluating the statistics for each configuration separately.

For a very general case, the invention could be used for error detection, wherein the two configurations are expected to yield the same results, and wherein a difference indicates an error in one of the configurations.

Advantages of the invention comprise:
Improved evaluation of the effect of implementing new features in a telecommunication system.
Comparison of different configurations which is less sensitive to variations in the traffic distribution in the system during measuring.

### BRIEF DESCRIPTION OF THE DRAWINGS

The invention, together with further objects and advantages thereof, may best be understood by making reference to the following description taken together with the accompanying drawings, in which:

FIG. 1 illustrates a flow diagram of an embodiment of a method according to the invention;

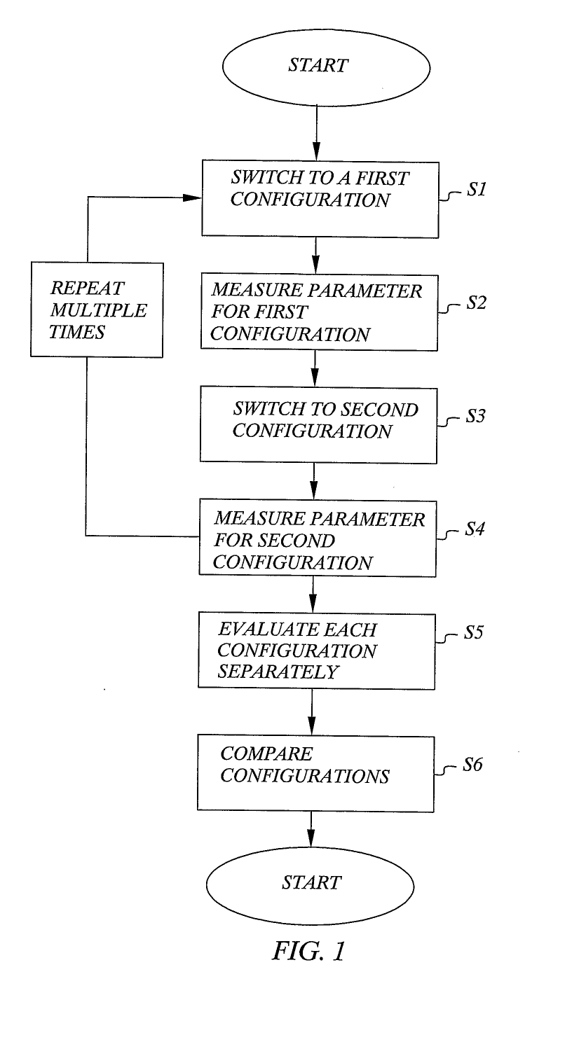

FIG. 2 illustrates an exemplary application of the present invention

FIG. 3 illustrates an embodiment of an arrangement according to the invention.

### DETAILED DESCRIPTION

The present invention will be described in the context of, but not limited to, a general telecommunication system. Instead, the invention is generally applicable to any system wherein several configurations need to be evaluated.

How is it possible to measure the effect when using a new or improved combination technique in the base transceiver station or the mobile station?

As an example, there are several different combination and interference suppression techniques used in today's mobile systems. For example, Ericsson GSM base transceiver stations have the feature Interference Rejection Combining (IRC) as an option. In GSM mobile stations, Downlink Advanced Receiver Performance (DARP, previously referred to as Single Antenna Interference Cancellation, SAIC) has been standardized and is likely to be implemented by several manufacturers.

In UMTS there are also different combination and interference suppression techniques, e.g. the Generalized RAKE (GRAKE) received etc.

For example, an operator buys the feature “4-antenna diversity” which is a different combination technique on the uplink in GSM. Then they want to measure the improved quality on the uplink. It is possible to measure the Bit Error Rate (BER) on the uplink and compare BER with the feature turned on and off. However, it may be difficult to draw any definite conclusions from such measurements. The reason is that the traffic in the cell between the on and off periods may be quite different. A higher BER during one of the periods does not necessarily have anything to do with the new combination technique, but may instead be connected to the location of the traffic in the cell, fading stat of own terminal or interferer, interference DTX etc. Since the measurement period must not be too short in order to collect reliable statistics (e.g. BER or BLock Error Rate BLER), and since the radio link connection may vary substantially even from one block to the next, the whole approach of switching on and off a feature may appear to be of little use.

However, as identified by the inventor, it is possible to enable reliable comparisons by switching between the two states/techniques/configurations rapidly, preferably within a limited time period.

The solution according to the invention basically comprises turning the feature to be evaluated repeatedly on and off with a short interval, for example every second burst, and collecting statistics separately for the on intervals and the off intervals, the collected statistics is little affected by the traffic distribution.

One solution, according to the invention, to the previously mentioned example with feature “4-antenna diversity” would be that the feature is turned on an off every second burst. Averaging all the odd bursts together will give one BER measure representing the feature turned on, and averaging all the even bursts will give the BER for feature turned off.

Accordingly, with reference to Fig, 1, an embodiment of a method of the present invention comprises switching S1, S3 between two or more configurations, and for each configuration measuring S2, S4 some predetermined parameter e.g. BER, BLER. The switching and measuring steps are repeated at least one time during a predetermined time period e.g. within a multiple of Transmission Time Interval. For each of the configurations the collected measurements are statistically evaluated S5. Subsequently, the evaluated parameters and consequently the configurations can be compared S6.

The statistical evaluation S5 can, according to one embodiment, comprise something as basic as averaging all collected measurements from one configuration over the entire predetermined time interval. However, it is obvious that any other more or less complex statistical analysis can be applied to the collected measurements.

According to a specific embodiment, the different configurations comprise one configuration with a new feature implemented and one configuration without the new feature.

According to another specific embodiment, the different configurations comprise one configuration operating as anticipated and one configuration malfunctioning or underachieving.

According to yet another specific embodiment, the different configurations comprise different interference suppression techniques in a telecommunication system.

According to yet another specific embodiment, the different configurations comprise different combination techniques in a telecommunication system.

In the above discussed embodiments, the predetermined parameter to be measured has been BER or BLER. However, it is understood that any quality measure or efficiency measure could be utilized e.g. bandwidth, signal strength, E/I, throughput etc.

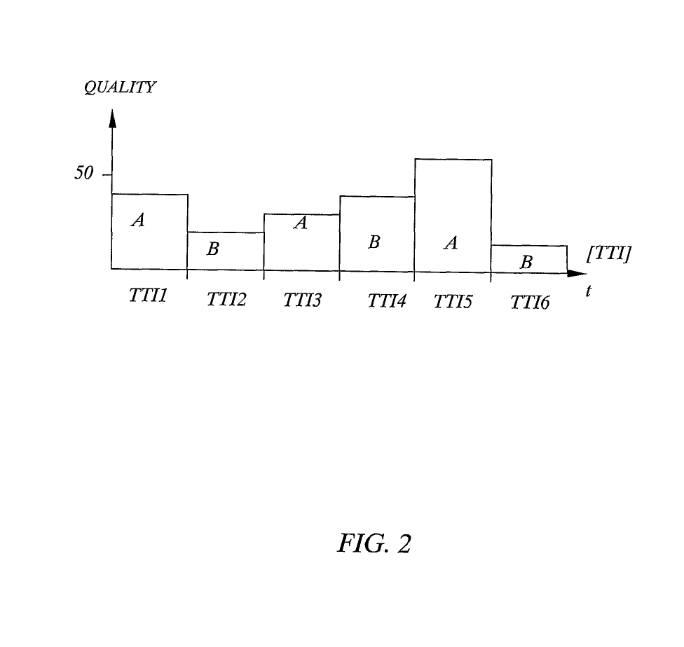

With reference to FIG. 2 an example of the utilization of an embodiment of the invention will be described.

Consider a hypothetical situation where an operator wants to compare two configurations A, B. The operator decides to measure some quality parameter Q. The invention is utilized as follows. Initially, during transmission time interval one TTI1, the operator switches to the A-configuration and measures the quality Q(A). Subsequently, in the next transmission time interval TTI2 the operator switches to the B-configuration and measures the quality Q(B). The switching and measuring steps are repeated for six consecutive transmission time intervals. The measuring results for each transmission time interval and each configuration are illustrated in the table below.

| TTI | Q(A) | Q(B) |
|---|---|---|
| TTI1 | 40 | — |
| TTI2 | — | 20 |
| TTI3 | 30 | — |
| TTI4 | — | 40 |
| TTI5 | 60 | — |
| TTI6 | — | 35 |

Subsequently, the quality measurements for each configuration are averaged over the respective set of transmission time intervals, yielding:

Q(A)=(40+30+60)/3=43.3

Q(B)=(20+40+35)/3=31.7

A subsequent comparison of the two configurations indicates that the A-configuration is the preferred configuration when studying the quality Q.

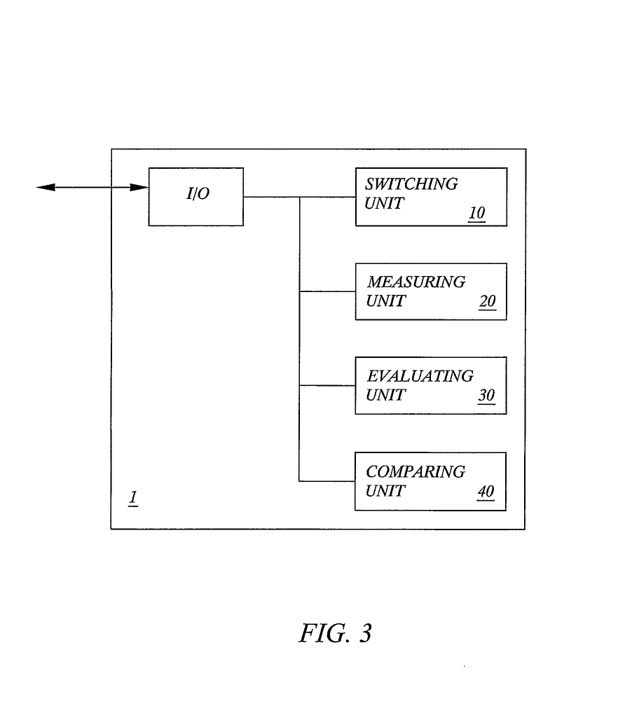

With reference to FIG. 3, an embodiment of an arrangement according to the invention will be described.

The arrangement 1 comprises a switching unit 10 operable to switch between different configurations, a measuring unit 20 operable to measure some predetermined parameter for each configuration, an evaluating unit 30 operable to statistically evaluate the collected measurements for each configuration separately, and a comparing unit 40 operable to compare the results from the statistical evaluation in order to compare the different configurations.

Preferably, the arrangement 1 is located in an operator controlled network unit e.g. radio base station. However, the arrangement can be located in any other unit which needs to be able to evaluate different configurations. Other possible locations for the arrangement according to the invention are different nods such as base station controller, Node B, radio network controller etc.

The methods and arrangements according to the invention are not limited to GSM, but are equally applicable to UMTS or other telecommunication systems. Also, comparisons of other techniques could also be considered not just different combining techniques. For example, it could be possible to compare GMSK and 8-PSK with the same kind of technique i.e. every second burst GMSK and every second burst 8-PSK.

Also, the invention can be applied to any general system where there is a need to compare different configurations and doing so relatively independently of the variations in the system. Such configurations could comprise a feature in an active/inactive state, an error free/erroneous configuration, different antenna configurations etc.

Advantages of the invention comprise:
Improved evaluation of the effect of implementing new features in a telecommunication system.
Comparison of different configurations which is less sensitive to variations in the traffic distribution in the system during measuring.

It will be understood by those skilled in the art that various modifications and changes may be made to the present invention without departure from the scope thereof, which is defined by the appended claims.

1. A method for comparing configurations in a telecommunication system, said method comprising the steps of:
switching to a first of said configurations;
measuring at least one predetermined parameter for said first configuration;
switching to at least a second of said configurations;
measuring the at least one predetermined parameter for said at least second configuration;
repeating said switching and measuring multiple times within a predetermined time interval; and
for each configuration statistically evaluating the collected predetermined parameters; and,
comparing the evaluated parameters, whereby the differences of the two configurations can be evaluated.

2. The method according to claim 1, further comprising the step of repeating said switching and measuring steps with a predetermined frequency.

3. The method according to claim 1, wherein said predetermined time interval comprises a plurality of transmission time intervals or bursts.

4. The method according to claim 2, further comprising the step of switching between said at least two configurations every second burst.

5. The method according to claim 3, further comprising the step of switching between said at least two configurations at least once every transmission time interval.

6. The method according to claim 3, further comprising the step of switching between said at least two configurations multiple times each transmission time interval.

7. The method according to claim 1, further comprising the step of evaluating the measured parameters by averaging the parameters collected for each configuration separately.

8. The method according to claim 1, wherein said at least one predetermined parameter comprises the bit error rate for each configuration.

9. The method according to claim 1, wherein one of said at least two configurations comprises a feature in an active state and another of said at least two configurations comprises the same feature in a deactivated state.

10. The method according to claim 1, wherein one of said at least two configurations comprises an error free configuration and another of said at least two configurations comprises a suspected erroneous configuration.

11. The method according to claim 1, wherein said configurations comprise GMSK and 8-PSK.

12. The method according to claim 1, wherein said configurations comprise different combination techniques in the telecommunication system.

13. The method according to claim 1, wherein said configurations comprise different interference suppression techniques in the telecommunication system.

14. The method according to claim 1, wherein said configurations represent different antenna configurations in the telecommunication system.

15. An arrangement operable in a telecommunication system, comprising:
means for switching between at least two configurations;
means for measuring at least one predetermined parameter for each configuration;
said switching means and said measuring means are adapted to repeat their switching and measuring action multiple times within a predetermined time interval;
means for statistically evaluating the collected measurements for each configuration separately; and,
means for comparing the results from the statistical evaluation.

16-17. (canceled)
